(19) United States
(12) Patent Application Publication
(10) Pub. No.: US 2015/0152681 A1
(43) Pub. Date: Jun. 4, 2015

(54) CURTAIN CORD WINDER STRUCTURE

(71) Applicant: Tser Wen CHOU, Taipei City (TW)

(72) Inventor: Tser Wen CHOU, Taipei City (TW)

(21) Appl. No.: 14/097,226

(22) Filed: Dec. 4, 2013

(51) Int. Cl. E06B 9/322; B65H 75/44

(52) U.S. Cl. CPC E06B 9/322; B65H 75/4481; E06B 2009/3225

(57) ABSTRACT

A curtain cord winder structure includes a cord winder base seat, a shaft, a cord reel, a movable cover board and a movable bracket. The curtain cord winder structure is characterized in that the cord reel includes an outer drum-shaped structure composed of multiple arched recessed wall faces and multiple arched raised wall faces that are connected with each other and an inner reinforcement structure formed on inner circumference of the cord reel. When the pull cord is wound around the outer drum-shaped structure of the cord reel, the pull cord is securely supported and located to save strength in operation of the pull cord. The inner reinforcement structure serves to reinforce the outer drum-shaped structure to avoid deformation of the cord reel.

### BACKGROUND OF THE INVENTION

1. Field of the Invention

The present invention relates generally to an improved curtain cord winder structure, and more particularly to a curtain cord winder structure, which makes it easier to operate the pull cord and control the opening/closing of the curtain slats. Moreover, the curtain cord winder structure can locate the curtain slats and prevent the pull cord from slipping downward.

2. Description of the Related Art

A cord winder is a device for controlling the opening/closing of curtain slats. The cord winder includes a cord reel on which the pull cord is wound. Two ends of the pull cord are pulled up and down to rotate the cord reel so as to drive the curtain slats to open or close.

There are various conventional cord reel structures. For example, U.S. Pat. Nos. 6,561,254, 5,636,677, 5,680,892 disclose some conventional cord reel structures. In these cord reel structures, the outer circumference and inner circumference of the cord reel are both smooth cylindrical structures. Therefore, when the pull cord is wound around the cord reel, there is no support point on the arched wall of the cord reel that can provide support force for the pull cord to truly rotate the cord reel. Therefore, in the conventional cord reel, the pull cord is wound around the cord reel by several loops to provide a binding force for operating the cord reel to rotate. In this case, it is hard to accurately locate the curtain slats and it often takes place that after located, the curtain slats still drop downward due to lack in support on the arched face of the cord reel. It can be known from the above that in practice, the conventional cylindrical cord reel structure of the cord winder has some problems and needs to be improved.

U.S. Pat. No. 2,491,917 discloses another type of cord reel structure. The cord reel structure is a polygonal drum body composed of multiple plane wall faces connected with each other. The drum body has multiple angles as blades. When the pull cord wound around the cord reel bears a pull force, the pull cord is forced against the angles and flattened. Under such circumstance, the pull cord is likely to damage. Therefore, such cord reel structure still needs to be improved.

### SUMMARY OF THE INVENTION

It is therefore a primary object of the present invention to provide a curtain cord winder structure, which is an improvement of the applicant's U.S. Pat. No. 6,761,204. The improvement of the curtain cord winder structure is that the cord reel includes an outer drum-shaped structure and an inner reinforcement structure. When the pull cord is wound around the outer drum-shaped structure of the cord reel, the pull cord is securely supported and located to save strength in operation of the pull cord. In addition, the inner reinforcement structure serves to reinforce the outer drum-shaped structure to avoid deformation of the cord reel. Accordingly, the problems of the conventional cylindrical cord reel that the pull cord cannot be supported and located and the cord reel is likely to deform are solved.

To achieve the above and other objects, the curtain cord winder structure of the present invention includes a cord winder base seat, a shaft, a cord reel, a movable cover board and a movable bracket. The curtain cord winder structure is characterized in that the cord reel includes an outer drum-shaped structure composed of multiple arched recessed wall faces and multiple arched raised wall faces that are connected with each other and an inner reinforcement structure formed on inner circumference of the cord reel. The inner reinforcement structure is reverse to the outer drum-shaped structure. (That is, in the case that the outer drum-shaped structure is a raised structure, the inner reinforcement structure is a recessed structure). When the pull cord is wound around the outer drum-shaped structure of the cord reel, the pull cord is securely supported and located to save strength in operation of the pull cord. The inner reinforcement structure serves to reinforce the outer drum-shaped structure to avoid deformation of the cord reel.

Accordingly, when the pull cord is wound around the outer drum-shaped structure of the cord reel, the pull cord is snugly attached to the arched raised wall faces, while the arched recessed wall faces are spaced from the pull cord by a gap to prevent the pull cord from being flattened. In addition, when pulling the pull cord, the angles at the junctions between the arched raised wall faces and the arched recessed wall faces serve as supports and force application points, whereby the cord reel can be easily rotated to save strength and more accurately operate the curtain. Moreover, the angles serve to locate the pull cord and prevent the pull cord from slipping downward.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective view of the cord reel of the present invention;

FIG. 3 is a side view of the cord reel of the present invention;

FIG. 4 is a perspective assembled view of the present invention;

FIG. 5 is a sectional assembled view of the present invention;

FIG. 6 is a sectional assembled view of the present invention, showing that the pull cord is wound around the cord reel;

FIG. 7 is a side sectional view showing that the pull cord is wound on the cord reel of the present invention; and

FIG. 8 is a side view of another embodiment of the present invention.

### DETAILED DESCRIPTION OF THE PREFERRED EMBODIMENTS

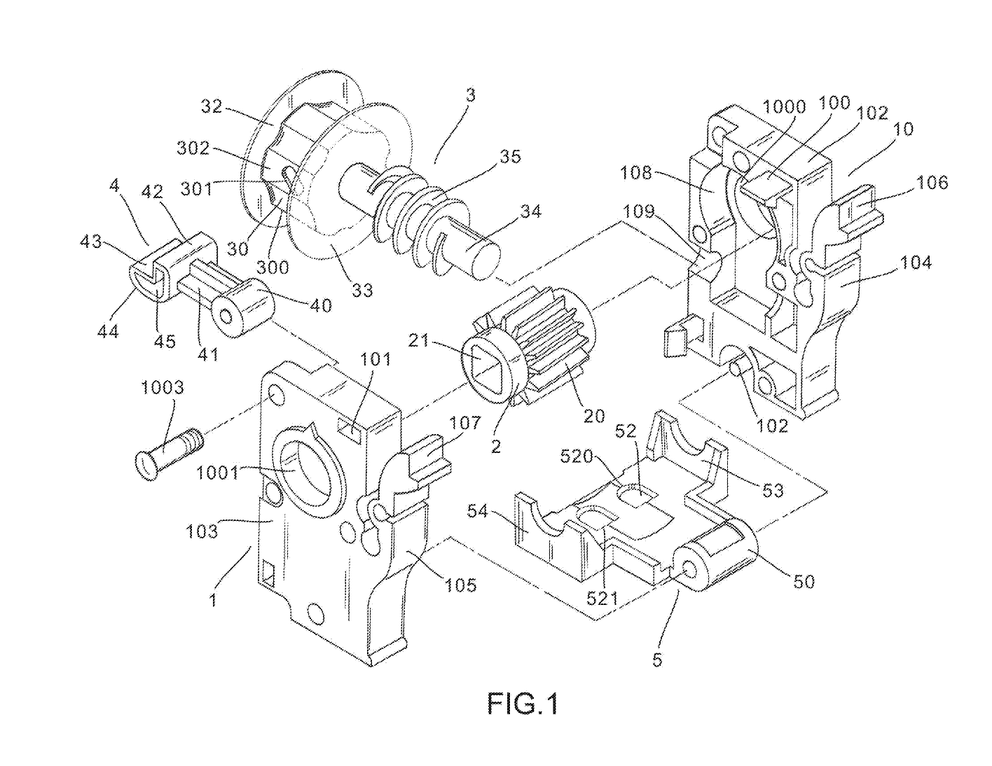

Please refer to FIG. 1. The curtain cord winder structure of the present invention is substantially identical to the applicant's U.S. Pat. No. 6,761,204. The present invention is only different from the above Patent in structure of the cord reel.

As shown in FIG. 1, the cord winder structure includes a left casing 1 and a right casing 10. The left and right casings 1, 10 are coupled and assembled with each other by means of tongues 100 and slots 101 to form a cord winder base seat. The cord winder structure further includes a shaft 2 enclosed in the interior of the left and right casings 1, 10 and a cord reel 3 drivingly engaged with the shaft 2 to outward protrude from the cord winder base seat. The cord winder structure further includes a movable cover board 5 upward turnable from an upper end of the cord winder base seat and a movable bracket 5 downward turnable from a lower end of the cord winder base seat.

The left and right casings 1, 10 have identical configurations. Each of the left and right casings 1, 10 includes a base case 102, 103. The base case 102, 103 has an elastic arm 104, 105 extending from one side of the base case 102, 103. The elastic arm 104, 105 has an engagement recess 106, 107 at top end for fixedly engaging with the rail of the curtain. An inner face of the base case 102, 103 is caved to form a receiving cavity 108, 109 for restricting and receiving the shaft 2 and a worm 35 on one side of the cord reel (the receiving cavity of the left casing 1 is not shown). The two receiving cavities 108, 109 communicate with each other. The bottom of the receiving cavity 108, 109 is formed with a perforation 1000 (1001), whereby the shaft 2 is rotatably received in the perforation 1000 (1001) and drivingly engaged with the worm 35 of the cord reel.

The shaft 2 has multiple teeth 20 annularly arranged on outer circumference of the shaft 2 for engaging with the worm 35 of the cord reel. The shaft 2 is formed with a passage 21 for a rectangular control bar (not shown) to pass therethrough. The rectangular control bar protrudes from the passage 21 and extends out of the perforation 1000 (1001) and is drivable by the shaft 2 to rotate therewith.

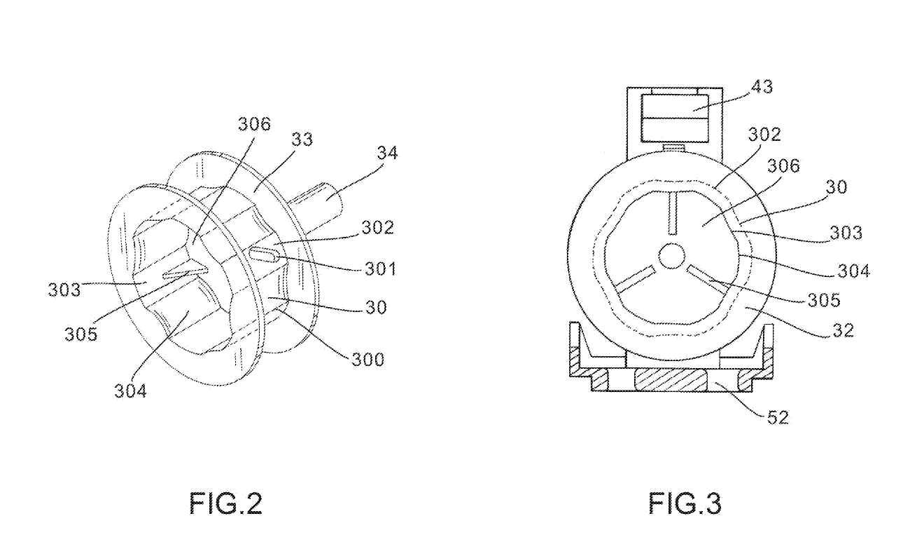

The cord reel 3 is positioned outside one side of the cord winder base seat. Referring to FIGS. 2 and 3, the cord reel 3 includes an outer drum-shaped structure 31 composed of multiple arched recessed wall faces 30 and multiple arched raised wall faces 302 that are connected with each other. The cord reel 3 further includes an inner reinforcement structure composed of multiple reverse arched recessed wall faces 303 and multiple reverse arched raised wall faces 304 that are connected with each other. Several reinforcement ribs 305 integrally extend from the arched recessed wall faces 303 for further reinforcing the outer drum-shaped structure 31. In addition, two disc sections 32, 33 with larger area radially extend from two sides of the polygonal outer drum body 31. The worm 34 outward protrudes from one disc section 33. The outer drum-shaped structure 31 has multiple angles 300. An oblique slot 301 is formed on one arched raised wall face 302 in adjacency to the inner disc section 33. The head of the pull cord is conducted through two ends of the oblique slot 301 and knotted to fix the head of the pull cord with the outer drum-shaped structure 31. The pull cord is wound around the outer drum-shaped structure 31, whereby the cord reel 3 can be rotated by means of pulling the pull cord. The worm 34 of the cord reel 3 has a thread 35. The shaft 2 and the cord reel are rotatably mounted in the receiving cavities 105, 106 and drivingly engaged with each other.

The movable cover board 4 includes a connection tubular body 40 and a support body 42 connected with the connection tubular body 40 via a connection stem 41. The support body 42 has a support mouth 43 for holding the rail of the curtain and an arched face 44 permitting the support body 42 to be pressed downward along the arched face of the rail of the curtain. Two sides of the support body 42 are formed with sockets 45 for reinforcing the support body 42. A bolt 1003 is passed through the movable cover board 4 to upward rotatably mount the movable cover board 4 in an upper cavity 105 of the cord winder base seat composed of the left and right casings 1, 10.

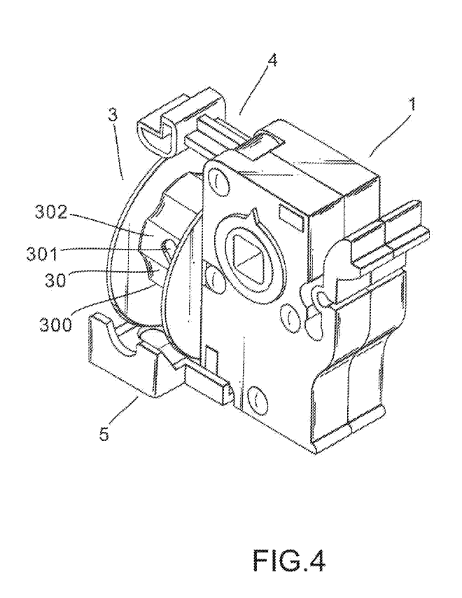

The movable bracket 5 includes a fitting tubular body 50 and a bracket section 51 extending from the fitting tubular body 50. The bracket section 51 is positioned under the cord reel 3 corresponding to the outer drum-shaped structure 31 for protecting the cord reel 3. The bracket section 51 is formed with several through holes 52 for the pull cord 6 wound on the cord reel to pass through. Each hole 52 has an arched front end 520 and a plane rear end 521. Two protection walls 53, 54 upward protrude from two sides of the bracket section 51 to protect two sides of the cord reel 3. The locating rods 1002 protruding from the left and right casings 1, 10 are inserted in the movable bracket 5, whereby the movable bracket 5 can be turned downward. The above components are assembled to form the main structure of the cord winder of the present invention (as shown in FIG. 4).

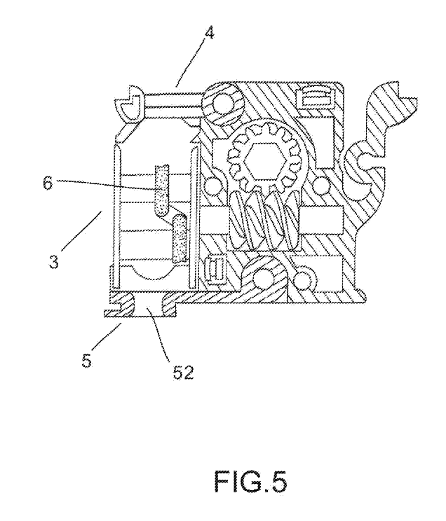

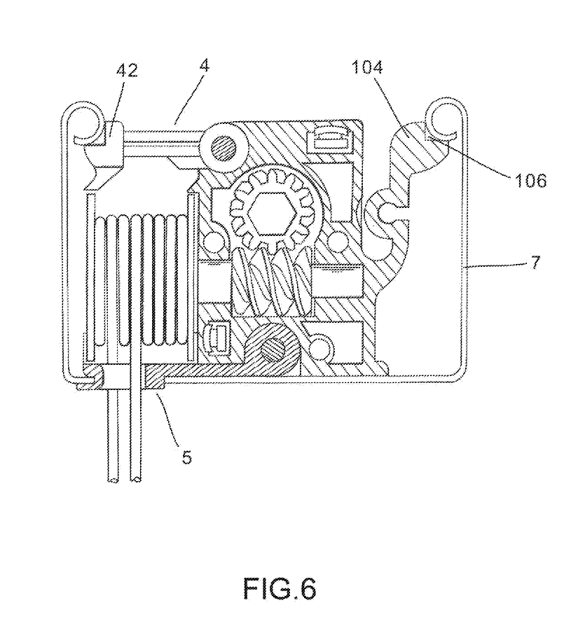

As shown in FIG. 5, when installed, the movable cover board 4 is turned upward to provide a winding space on upper side of the outer drum-shaped structure 31. The movable bracket 5 is turned downward to provide a winding space under lower side of the outer drum-shaped structure 31. In this case, it is easy to wind the pull cord 6 around the outer drum-shaped structure 31 of the cord reel. The suspending two ends of the pull cord 6 are conducted through the holes 52 of the movable bracket 5 to a user's hand to hold to control the rotation of the cord reel 3. Then, the engagement recesses 106, 107 of the elastic arms 104, 105, the movable cover board 4 and the movable bracket 5 are supported on the rail 7 of the curtain to fix the entire cord winder base seat in the rail 7 of the curtain (as shown in FIG. 6).

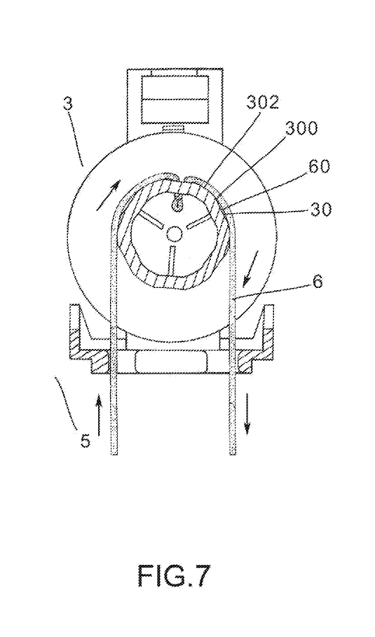

Referring to FIG. 7, when the pull cord 6 is wound around the outer drum-shaped structure 31 of the cord reel 3, the pull cord 6 is snugly attached to the arched raised wall faces 302, while the arched recessed wall faces 30 are spaced from the pull cord 6 by a gap 60 to prevent the pull cord 6 from being flattened. In addition, the angles 300 at the junctions between the arched raised wall faces 302 and the arched recessed wall faces 30 serve as supports and force application points, whereby the cord reel 3 can be easily rotated to save strength and more accurately operate the curtain. Moreover, the angles 300 at the junctions between the arched raised wall faces 302 and the arched recessed wall faces 30 serve to locate the pull cord 6 and prevent the pull cord 6 from slipping downward.

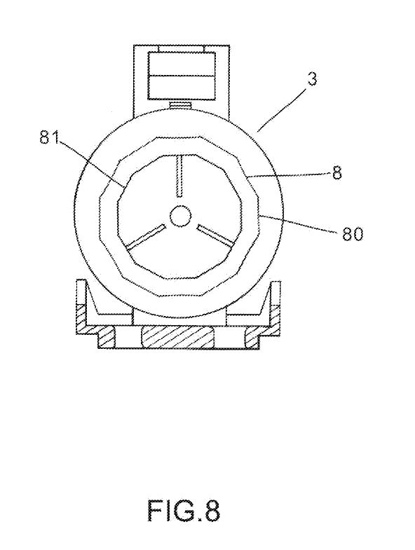

Please now refer to FIG. 8, which shows another embodiment of the present invention. In this embodiment, the outer drum-shaped structure 31 of the cord reel 3 is composed of multiple arched recessed wall faces 8 and multiple plane wall faces 80 that are connected with each other. The inner reinforcement structure is composed of multiple plane wall faces 80 that are connected with each other. The number of the plane wall faces 80 of the inner reinforcement structure is equal to that of the arched recessed wall faces 8 and plane wall faces 80 of the outer drum-shaped structure 31. This can also save strength and more accurately operate the curtain as well as prevent the pull cord from slipping downward.

The above embodiments are only used to illustrate the present invention, not intended to limit the scope thereof. Many modifications of the above embodiments can be made without departing from the spirit of the present invention.

What is claimed is:

1. A curtain cord winder structure comprising:
a cord winder base seat composed of a left casing and a right casing, each of the left and right casings having an inner face formed with a receiving cavity;
a shaft having multiple teeth on outer circumference, the shaft being mounted in the receiving cavities;
a cord reel including a drum body, two disc sections having larger area and radially extending from two sides of the drum body and a worm outward protruding from one of the disc sections, the worm being correspondingly engaged with the teeth of the shaft for driving the shaft to rotate within the receiving cavities;
a movable cover board having a support body, the movable cover board being upward rotatably mounted at an upper end of the cord winder base seat; and
a movable bracket having a bracket section formed with several through holes, the movable bracket being downward rotatably mounted at a lower end of the cord winder base seat, the curtain cord winder structure being characterized in that the cord reel includes an outer drum-shaped structure composed of multiple arched recessed wall faces and multiple arched raised wall faces that are connected with each other and an inner reinforcement structure formed on inner circumference of the cord reel, the inner reinforcement structure being reverse to the outer drum-shaped structure.

2. The curtain cord winder structure as claimed in claim 1, wherein the inner reinforcement structure is composed of multiple arched recessed wall faces and multiple plane wall faces that are connected with each other.

3. The curtain cord winder structure as claimed in claim 1, wherein the inner reinforcement structure is composed of multiple plane wall faces that are connected with each other.

4. The curtain cord winder structure as claimed in claim 1, wherein the outer drum-shaped structure is composed of multiple arched recessed wall faces and multiple plane wall faces that are connected with each other.

5. The curtain cord winder structure as claimed in claim 1, wherein the inner reinforcement structure further includes several reinforcement ribs.

6. The curtain cord winder structure as claimed in claim 1, wherein an oblique slot is formed on one of the arched raised wall faces of the cord reel in adjacency to the inner disc section of the drum body.
